(19) United States
(12) Patent Application Publication
(10) Pub. No.: US 2009/0104369 A1
(43) Pub. Date: Apr. 23, 2009

(54) METHOD FOR PRODUCING FUNCTIONAL GLASS SURFACES BY CHANGING THE COMPOSITION OF THE ORIGINAL SURFACE

(75) Inventors: Markku Rajala, Vantaa (FI); Sampo Ahonen, Espoo (FI); Joe Pimenoff, Helsinki (FI); Joonas Ilmarinen, Helsinki (FI); Anssi Hovinen, Espoo (FI); Kai Asikkala, Helsinki (FI); Jukka Santahuhta, Hameenlinna (FI)

Correspondence Address: OLIFF & BERRIDGE, PLC, P.O. BOX 320850, ALEXANDRIA, VA, 22320-4850, US

(73) Assignee: BENEQ OY, Vantaa (FI)

(21) Appl. No.: 12/294,206

(22) PCT Filed: Mar. 26, 2007
(86) PCT No.: PCT/FI07/50163

§ 371 Date: Oct. 10, 2008

(30) Foreign Application Priority Data
Mar. 27, 2006 (FI) 20060288

(51) Int. Cl. B05D 1/06

(52) U.S. Cl. 427/475

(57) ABSTRACT

A method for modifying glassy surfaces including: producing nanoparticles; depositing the said nanoparticles on a surface; providing energy to the particles and/or surface so that the nanoparticles are at least partly diffused/dissolved into the glassy surface; and reducing the cohesive energy of the nanoparticles during the production of the nanoparticles or after the production of the nanoparticles.

### TECHNICAL FIELD

This invention relates to the modification of glass-like surfaces, like glass surfaces, glazes and enamels according to the preamble of claim 1, and particularly by producing nanoparticles, depositing the said nanoparticles on a surface, providing energy to the particles and/or surface so that the nanoparticles are at least partly diffused/dissolved into the glassy surface for providing the surface a function which does not necessarily exist in the original glass-like surface.

### BACKGROUND ART

Various functions may be provided to a glass-like surface. These include e.g. energy-saving surfaces (low-emissivity and/or solar control glasses), tinted glasses, self-cleaning/easy-cleaning glasses, surface strengthened glasses, glasses with improved chemical durability, bio-compatible glasses, etc. In these applications the glass surface plays an outstanding role and a functionality not existing in the original glass-like surface may be achieved by changing the composition of the glass surface. The new functionality may arise solely from the new glass composition or the new composition provides a surface for adhering different coatings on glass or there may be a combination of these two processes.

### Energy-Saving Glasses

Low-e coatings are spectrally selective thin-film coatings deposited on float glass. Traditionally either chemical vapor deposition (CVD) or physical vapor deposition (PVD) is used for deposition. In general, the CVD-coated products (pyrolytic coatings, hard coatings) are harder and chemically more durable. The sputter-deposited coatings (soft coatings) have better spectral selectivity (M. Arbab, L. J. Shelestak and C. S. Harris, Value-Added Flat-Glass Pro-Products for the Building, Transportation Markets, Part 2, Americal Ceramic Society Bulletin, Vol. 84, No. 4, 2005, pp. 34-38).

Window Energy Ratings have been launched in many countries, e.g. by the British Fenestration Rating Council (BFRC). A window's Rating is determined by a formula which takes into account its total solar heat transmittance (usually referred to as g value), U value and air infiltration. The resulting value is then placed into a band on an A-G scale. This makes the system of rating windows consistent with other products which have energy performance labels. BFRC Ratings take into account both the positive (solar gain) and negative (heat loss) aspects of the glass. With low-e glass, hard coat products have a greater heat loss but a higher solar gain than soft coat products. The overall BFRC Rating of a window is dependent on much more than these two factors (for example frame area, frame U value and air-tightness), but in general any given window will be rated in the same category, irrespective of whether it contains hard coating or soft coating (Helena Bülow-Hübe, A breakthrough for coated glazing in Sweden. Will double-pane windows take over the market?, Energi och Miljö, N:o 2, 2002). This is because the increased heat loss of a window containing hard coating is balanced by its improved solar gain. The solar gain is obviously beneficial mainly in the northern climates. However, also in the cooling-dominated climates, low-e coatings can be beneficial if the solar heat gain coefficient (SHGC) can be minimized (David R. Howell, Richard Silberglift, Virginia Arlington and Douglas Norland, Industrial Materials for the Future R&D Strategies: A Case Study of Chemical Vapor Deposition (CVD) Methods—Applying Low-e Coatings to Flat Glass for Applications in Sunbelt Locations, prepared for Industrial Materials for the Future Program, Office of Industrial Technologies, U.S. Department of Energy, October 2002). In general: for buildings where heating is of prime importance the U-value should be as low as possible and the g-factor as high as possible. For buildings where cooling is of prime importance the g-factor should be as low as possible (with maintained visible light transmittance). For buildings requiring both heating and cooling, a low U-value and a low g-factor saves heating and cooling. For some cases it is optimal to have different windows in different directions. In cold climates it is beneficial to focus on low U-values fort north directions and high g-factors for south directions (Joakim Karisson, Windows—Optical Performance and Energy Efficiency, Dissertation for the Degree of Doctor of Philosophy in Solid State Physics presented at Uppsala University in 2001). There is no single window optimal for all these purposes.

A key tool in a designer's arsenal to combat excessive heat and light rays are window tints, which are absorptive materials available in both glass and plastic glazing. Tints absorb a portion of solar radiation and transform it into heat within the glass. Depending upon the interior and exterior climatic conditions, some of this heat may also be transferred to the building interior.

The application of tints to glass, which is typically added to the material while in the molten stage of manufacturing, lowers the shading coefficient (SC) of clear glass by reflecting and absorbing some of the light and solar heat. Common colored tints are grey, bronze, blue, green, and combinations of these shades. The tint's level of absorption depends on the absorbing material (tint) and the thickness of the glass. Grey glass transmits approximately equal amounts of visible light and infrared. Bronze glass transmits less visible and more infrared than grey glass. Blue and green glasses transmit more visible light and less infrared than grey glass.

Spectrally selective tints, such as blue and green tints, are naturally selective to visible light. These tints are more selective in the visible and near-infrared spectrum than traditional tints and maintain relatively low shading coefficients and high transmission of visible light.

Blue-, green-, and aqua-tinted glass have been engineered during the past 15 years to increase spectral selectivity with a clearer appearance. These spectrally selective tints can provide increased solar control when combined with a selective low-e coating. For best performance, tinted glazings should be used in an insulating glass unit with the tinted pane on the exterior to minimize reradiation of absorbed heat to the interior.

Roughly 95% of the thermal energy from bodies at 21° C. is emitted in the 5-40 μm region of the electromagnetic spectrum. Uncoated glass is a high-emissivity material. It absorbs and reemits heat in this region (emissivity=0.84). In contrast, an electrically conductive coating on glass reflects this thermal radiation and has low emissivity.

Most commercial pyrolytic low-e coatings consist of transparent conductive oxides (TCO) that are good reflectors in the thermal radiation range (emissivity=0.2). A prime example of such a coating is fluorine-doped tin oxide (F:SnO₂), which is an n-type semiconductor.

Generally, higher conductance of the coatings results in a lower emissivity for the product. Therefore, at a given conductivity, the film should be thick enough to meet the emissivity requirement for its intended use. F:SnO₂ has a relatively high index of refraction (˜2.0) compared with glass (1.5). At typical low-e coating thicknesses, F:SnO₂ can impart high reflectance and undesirable color to the glass product. Therefore, the glassmaker inserts an optical under-layer coating between the functional low-e film and the glass substrate for color suppression.

Since economics drive technology in the glass industry, the push is towards faster and better online coating processes. Flat-glass producers face the dual challenge of increasing the market share for coated products while minimizing cost. For offline coating, this means developing new materials, deposition of new materials at commercial speeds, and formation of new structures with increased abrasion and corrosion resistance. Online deposition holds great promise for exploiting the large economies of scale enabled by the continuous float-glass process.

Several barriers have been inhibiting the industry from reaching new performance targets. The number of barriers indicates that the industry is facing major challenges in developing the next generation of coatings, which must perform better in all respects than existing ones while also being considerably cheaper in many instances. Key barriers included e.g.: lack of durability in active and passive coatings; lack of precursor materials with appropriate properties; lack of online process control; and low yields for coating processes.

In U.S. Pat. No. 2,564,708 it is noticed that the oxides of Cd, In, Sn and Sb reflect electromagnetic radiation with the wavelength longer than 2 μm. The combination of solar energy absorption and IR-reflection was described in U.S. Pat. No. 3,473,944.

In U.S. Pat. No. 3,652,246 glass coloring by spray-pyrolysis was described and the patent basically describes the technology which can also be used to produce low-e coatings by spray-pyrolysis. In the same year PPG also patented the use of CVD in glass coating production (U.S. Pat. No. 3,850,679) with a restriction that the Reynolds number in the CVD nozzle is greater than 2500, i.e. the reactant gas/vapor flow is turbulent.

U.S. Pat. No. 4,952,423 discloses a fluorine-doped tin oxide low-e coating with claim 1 as: ‘A method for manufacturing a transparent, electrically conductive member, by forming an electrically conductive layer on a transparent substrate, comprising the steps of: heating the substrate to a first deposition temperature; thermally decomposing and oxidizing a tin compound in the vicinity of the substrate under conditions such that a tin oxide layer is deposited on the substrate; bringing a halogen containing doping material into the vicinity of the substrate during the deposition step, whereby said tin oxide layer is doped as it is deposited; and without thereafter raising the temperature of the deposited doped layer above the deposition temperature, performing a heat treatment on the doped tin oxide layer at a temperature between 250° C. to 400° C.

In U.S. Pat. No. 4,187,336 Gordon describes the use of one or several undercoats (or gradual coating) to remove the iridescence. Gordon deposited the coatings by CVD. Gordon also describes haze in his patent and claims that it can be removed by an undercoating of SiO₂, Si₃N₄ or GeO₂.

Preventing sodium diffusion is covered by various patents. Alumina has been used in sodium halide discharge lams as a barrier zone against sodium diffusion (U.S. Pat. No. 4,047,067). Fused silica tubes were coated with aluminum oxide which had been preheated to 800° C. Thereafter the silica tube was surface-heated, for instance by an oxyhydrogen torch to a temperature sufficient to fuse the alumina into the silica surface. Graded alumina silicate layers which were between 5-25 μm thick with peak concentrations ranging from 5-25 wt-% aluminum oxide were obtained.

A similar process was used with titania (titania layer on silica tube heated and a graded layer of titania-silica was formed) and a decrease in the sodium ion conductivity was observed (U.S. Pat. No. 3,988,628; U.S. Pat. No. 4,091,163).

Tantalum oxide has also been used as a barrier layer against sodium diffusion and it has been shown to be superior to an Al₂O₃ layer (U.S. Pat. No. 5,476,727)—but these layers were crystalline, not doped glass layers. However, the structure and coordination of Ta₂O₅ could prefer network modification in a way that it would prevent sodium diffusion. However, this could be true for any cation with a high coordination number.

Amorphous metal oxide layers of titanium oxide, zirconium oxide and zinc/tin oxide have been shown to be effective as alkali metal barrier layers at thicknesses below 18 nm (U.S. Pat. No. 5,830,252). The US patent by PPG is limited to sputtering.

Of all the oxides, addition of ZrO₂ is known to increase the durability of silicate glasses most. Even a small amount of ZrO₂ (about 2 wt-%) increases acid and alkaline durability of glass significantly. The problems with ZrO₂ may arise from its very high melting and boiling points (2700° C./5000° C. respectively, compared to 2000° C./3000° C. of Al₂O₃).

Typically SiO₂ barrier layers are used to prevent sodium diffusion, but these are not very efficient as the network is pretty open to alkali diffusion. This may be improved by adding hydrogen to the silica structure (EPO 071 865) or by adding TiO₂, Al₂O₃, ZrO₂, MgO or NiO to silica (U.S. Pat. No. 4,238,276).

U.S. Pat. No. 5,089,039 claims ‘A method of pyrolytically forming a silicon oxide coating on a hot glass substrate as it travels through a coating chamber along a substrate path, the method comprising: a. intimately mixing a coating precursor material which contains silane and which is in vapor phase, and gaseous oxygen to form a gaseous mixture before introduction thereof into the coating chamber; b. introducing the gaseous mixture into the coating chamber; and c. contacting the hot glass substrate as it travels through the coating chamber with the gaseous mixture to pyrolytically form the silicon oxide coating thereon’.

A undercoat preserving in a incompletely oxidized state is described in U.S. Pat. No. 5,203,903, the description claiming that by controlling the oxidation state of silicon dioxide, the refractive index of the undercoating can be controlled (or actually the n/thickness ratio). U.S. Pat. No. 5,221,352 also describes the formation of silicon oxide undercoat. According to the invention, there is provided a method of pyrolytically forming a silicon oxide coating on a hot glass substrate as it travels past a coating chamber by contacting the substrate with silane-containing coating precursor material in the presence of oxygen, characterised in that silane-containing coating precursor material in the vapour phase and gaseous oxygen are intimately mixed before they enter the coating chamber to contact the substrate.

U.S. Pat. No. 5,221,352 states that it is advantageous to deposit the silica undercoat in the tin bath, the patent describing: ‘It is rather surprising to propose to form an oxide coating within a float chamber. Float chambers contain a bath of molten metal, wholly or mainly tin, which is rather easily oxidisable at the temperatures required for the glass ribbon to spread out and become fire-polished, and accordingly it is universal practice to maintain a reducing atmosphere within the float chamber, because any surface dross picked up by the glass ribbon from the surface of the metal bath would be a source of defects in the glass produced. Typically such atmosphere contains about 95% nitrogen and about 5% hydrogen and it is maintained at a slight overpressure to prevent oxygen from leaking into the float chamber from the ambient atmosphere. Much research has also gone into removing dross which almost always forms on the surface of the metal bath despite all the precautions taken to avoid allowing oxygen into the float chamber. It therefore goes against the tide of the teaching about the production of float glass deliberately to maintain oxidising conditions in the float chamber. We have however found that it is possible to create oxidising conditions within a float chamber without giving rise to the expected problems. We believe that this is at least in part due to the fact that said coating precursor material is brought into contact with said face in a coating chamber. The use of a coating chamber facilitates confinement of the oxidising conditions, of the coating precursor material, and of the coating reaction products so that their effect on the bath of metal in the float chamber can be rendered small or negligible.’

U.S. Pat. No. 5,221,352 does not restrict the method to silica coatings only, but states: ‘Apparatus for pyrolytically forming an oxide coating on an upper face of a moving, hot glass substrate, comprising: a. a substrate path and a downwardly opening hood positioned along the substrate path and defining together with the substrate path a coating chamber; b. support means for conveying a hot glass substrate along the substrate path past the coating chamber; c. means for introducing coating precursor material in the vapor phase into a carrier gas stream comprised of a carrier gas including means for inducing turbulence in the carrier gas stream to ensure intimate mixing of the carrier gas and the coating precursor material; d. means including at least one venturi for introducing oxygen into the precursor-containing carder gas stream before it enters the coating chamber and provide a gas mixture stream; e. means for supplying to the coating chamber the gas mixture stream; and f. means for aspirating atmosphere including coating reaction products and unused coating precursor material from the coating chamber.

U.S. Pat. No. 6,106,892 describes a method of depositing a silicon oxide coating on a hot glass by CVD. The silicon oxide is doped and has a surprisingly low refractive index, claim 1 stating: ‘A method of depositing a silicon oxide coating on a hot glass substrate by chemical vapor deposition which comprises: providing the hot glass substrate, forming a gaseous mixture comprising a silane and an ester selected from the group consisting essentially of a phosphorus ester and a boron ester, directing the gaseous mixture towards the hot glass substrate, and contacting the substrate with the gaseous mixture at substantially atmospheric pressure, thereby depositing the silicon oxide coating on the hot glass substrate, wherein the deposited silicon oxide coating has a refractive index not greater than 1.5.’

Various patents on the pyrolytic low-e production method exists. One of the first ones is U.S. Pat. No. 4,293,326 describing ‘a process of coating glass with tin oxide by exposing the glass to a gaseous medium containing tin tetrachloride vapor under conditions causing formation of the oxide coating by chemical reaction and/or decomposition. The glass is moved continuously through the coating zone’.

U.S. Pat. No. 4,329,379 combines the undercoating deposition to the same process: ‘A tin oxide coating is formed on a hot glass substrate during conveyance through two successive coating zones in the first of which it is contacted with an acetylacetonate or alkylate of titanium, nicke or zinc to cause deposition of a metal oxide undercoating on the substrate, and in the second of which zones such metal oxide coatings on the still hot substrate is contacted by a gaseous medium comprising a tin halide to cause deposition of a coating of tin oxide.

US patents U.S. Pat. No. 4,330,318, U.S. Pat. No. 4,349,369, U.S. Pat. No. 4,349,370, U.S. Pat. No. 4,349,371, U.S. Pat. No. 4,349,372,U.S. Pat. No. 4,414,015, U.S. Pat. No. 4,536,204, U.S. Pat. No. 4,598,023, U.S. Pat. No. 4,655,810, U.S. Pat. No. 4,664,059, U.S. Pat. No. 4,728,353, U.S. Pat. No. 4,880,698, and U.S. Pat. No. 4,917,717 describe various technical solutions for producing uniform coatings on a glass ribbon.

Various patents also exist for the solar coatings, i.e. coatings which absorb solar energy. U.S. Pat. No. 5,721,054 describes a glazing panel where one absorbent coating layer comprises at least one metal oxide selected from the oxides of chromium, cobalt and iron. A non-abosrbent coating layer is in contact with absorbent layer and improves the aesthetics of the glazing. U.S. Pat. No. 6,048,621 describes a solar control glass with a coating comprising a heat absorbing layer and low emissivity layer on the heat-absorbing layer. Preferred heat absorbing layers absorb preferentially at wavelengths above 700 nm and may be e.g. non-stoichiometric or doped tungsten oxide, cobalt oxide, chromium oxide, iron oxide or vanadium oxide. On the heat absorbing layer sits a low-e layer. The coatings are suitable for deposition on-line on the glass ribbon by pyrolytic methods for example CVD. Claim 1 states: ‘A high performance solar control coated glass comprising a glass substrate with a coating comprising a heat absorbing layer and a low emissivity layer of a metal compound, wherein the low emissivity layer of the coating overlies the heat absorbing layer, and wherein the low emissivity layer has a thickness in the range 100 nm to 600 nm and wherein the coated glass has an emissivity of less than 0.4 protecting the product, not the production method.

U.S. Pat. No. 6,827,970 describes niobium doped tin oxide low-e coating claiming that it has properties comparable or superior to conventional low E glass with fluorine doped tin oxide coatings. No emissivity data was provided to support the claim.

Attempts to reduce haze have mainly been two-fold: reducing sodium diffusion or smoothing the glass surface. In his U.S. Pat. No. 5,631,065 Gordon describes an energy-conserving window glass with very low scattering of visible light. A typical structure of such glass consists of soda-lime glass coated successively with alumina, then fluorine-doped tin oxide and finally with bismuth silicate glass. The whole structure is heated so that the bismuth silicate glass softens and flows to form a smooth surface.

Low emissivity coatings are not well suited for use in warmer climates since low-e coatings transmit a high percentage of solar energy, thus increasing cooling costs. In warmer climates, coatings which provide not only low emissivity but also solar control properties, such as solar energy reflection or absorption or low shading coefficient, are desirable. Tin oxide doped with certain materials, such as antimony (Sb), can have solar energy reflecting and absorbing characteristics. The advantages of both low emissivity and solar control can be obtained by providing a coating having both a low emissivity coating material, such as fluorine doped tin oxide, with a solar control coating material, such as antimony doped tin oxide, or by providing a coating having mixed emissivity and solar control materials, such as tin oxide doped with both antimony and fluorine. An example of one such coating is disclosed in GB 2,302,102. U.S. Pat. No. 6,797,388 describes a coating which has a substantially crystalline first layer with a substantially crystalline second layer provided over the first layer. A breaker layer is provided is provided between the first and second layers and is configured to prevent or at least reduce epitaxial growth of the second layer on the first layer and by that way reduce the haze caused by the layers.

### Tinted Glasses

Coloring of glass means in wide scale changing the interaction of glass and the electromagnetic radiation so that the transmission of the radiation through the glass, absorption into glass or defraction of the substances in the glass changes. The most important wavelength ranges are ultraviolet (e.g. preventing the sun's ultraviolet radiation through the glass), area of visible light (changing the color of the glass visible to human eye), near infrared range (changing the transmission of the infrared radiation of the sun or glass material used in active optical fibers) and the near infrared range (changing the transmission of the heat radiation).

The coloring of the glass is typically carried out by two alternative methods: body tinted glass is manufactured by adding into the molten glass mass substances producing a characteristic color into the glass. The surface dyed glass is manufactured by setting the glass in contact with the combination of dyeing compound, when the coloring substance is transferred into the glass by ion change (stained glass). Glass can also be coated with glazing or an enamel layer to produce the color surface.

The body tinted glass is manufactured by adding into the glass components of coloring metals such as iron, copper, chrome, cobalt, nickel, manganese, vanadine, silver, gold, rare earth elements or similar. A component like this results a certain wavelength absorption or defraction and thus producing a characteristic color. Adding the coloring compound to the molten glass mass means that changing the color is extremely expensive and timely operation. Thus especially producing small glass parties is expensive.

The color of glass, transmitting light and permeability of ultraviolet light depends in a complex way on the compounds of the glass. The behavior and characters of the compounds in the glass mass depend on their oxidation/reduction stage (valence) and whether the metal forms or changes the structure. The valence is influenced essentially by other raw materials of glass such as other metals.

Nickel oxide is used often when the glass is colored grey. When the glass is produced by float process, a molten glass ribbon moves over a tin bath. In order to prevent the oxidation the atmosphere over the tin bath is reducing. This, however, causes the reduction of nickel on the glass surface and producing on the glass surface a shade of metallic nickel, which weakens the quality of glass. To remove this problem nickel free grey glass compositions have been developed, for example a method presented in U.S. Pat. No. 4,339,541. The method is still based on body tinted glass (coloring of the molten glass).

U.S. Pat. No. 2,414,413 has presented a method in which method the glass mass is added with reductive substances such as silica or mixtures containing silica, which prevents the evaporation of selene of molten glass mass.

U.S. Pat. No. 4,748,054 has presented a method for coloring glass with pigment layers. The glass is sand blasted and various enamel layers are pressed on the surface and then burned onto the surface. The chemical and mechanical durability is weak.

Stained glass is a hundred years old technique based on ion change on the surface of the glass. This method has been used commonly when the glass is colored red or yellow with silver or copper. Typically copper or silver salt is mixed with a suitable solvent and the mixture is added with water which produces a slurry with a suitable viscosity. This slurry is then spread on the glass to be dyed and the glass item is heated typically to a few hundred grades when ion change takes place and the glass is colored dyed. After this the dried slurry is removed from the glass surface by washing and brushing. The method is not suitable to industrial use as such.

U.S. Pat. No. 1,977,625 presents a altered glass surface dyeing based on that on the hot surface (ca 600° C.) is spread a solution containing both the salt of coloring metal (patent example silver nitrate) and reducing substance such as sugar, glycerin or Arabic cum. The solution contains also a fusing agent, which causes the melting point of the glass surface to drop and the dyeing ions diffuse into the glass. A fusing agent like this can be for example a combination of lead and boron. However, the usage of fusing agent causes commonly weakening of the chemical and/or mechanical durability of the glass surface and the method is thus not commonly applicable.

U.S. Pat. No. 2,075,446 presents a method for tinted glass, in which method the glass item is for a limited/certain time sink into molten metal salt, from which silver or copper ions are due to ion change transferred into the glass ware producing a colored surface. Due to the sinking stage the method is not commonly useful in glass production, since it cannot be used e.g. in the production of float glass on a float line.

U.S. Pat. No. 2,428,600 presents a method for the production of stained glass, in which method glass containing alkaline metals is in contact with evaporating copper halide, the ions of alkaline metals within the surface layer of the glass are changed into copper ions, and the glass is flushed with hydrogen gas. Copper is reduced by hydrogen and color is produced on the glass surface. Basically the same production method, but the process steps occurring in reversed order is presented in U.S. Pat. No. 2,498,003.

U.S. Pat. No. 2,662,035 presents several copper/silver/zinc combinations, which produce various colors into the glass surface. The patent method for coloring glass consists of covering the glass surface by dispersion, from which the metal ions are changed into the glass surface.

U.S. Pat. No. 3,967,040 presents a method for glass tinting, in which method the reducing metal (preferably tin) arising as an impurity in the glass surface due to the float manufacturing process or inserted on the glass surface by some other way, acts as a reducer so that tinting the glass with salt containing silver creates the characteristic color. The coloring substance is the coloring metal salt in contact with the glass.

U.S. Pat. No. 5,837,025 presents a method for coloring the glass with nanosized glass particles. According to this method glass-like, colored glass particles are produced and directed onto the surface of the glass to be colored and sintered transparent glass on a temperature under 900° C. The method is differs from this present invention so that the present invention the particles are diffused into the glass and do not form a separate glazing on the glass surface.

### Glass Weathering and Soiling and Self-Cleaning Glass

Soiling is a visual nuisance resulting from the darkening of exposed surfaces by deposition of atmospheric particles. Soiling is a 2-kinetics phenomenon. In soiling carbonaceous soot and, in a lesser extent, soluble salts accumulate on the glass surface, modifying its transparency. During the first stage soiling increases to maximum, then during the second phase, it decreases to zero attaining saturation. The first stage corresponds to the capture of particles by the reactive sites present on the glass surface and its consequent progressive covering Modifying the glass surface such that the amount of reactive sites on the glass surface is reduced can reduce the soiling rate (Atmospheric Environment, 39 (2005), Lombardo, T., et.al., “Soiling of silica-soda-lime float glass in urban environment: measurements and modeling”, pp. 989-997).

Soda-lime-silica float glass undergoes a leaching process (weathering) when exposed to humidity, rainwater and pollution. Slight differences in the weathering behavior of the two sides of loat glass have been observed: the ‘tin bath’ side seems to be more resistant than the ‘air’ side. Leaching results in the formation of a very thin layer (a few tens of nanometers) which is characterized by the depletion primarily of sodium and parallel enrichment of silicon and hydrogen containing species. The thickness of this modified layer increases with time. After longer exposure times chemical modifications continue to take place on the subsurface (Glass Technol., vol. 46 (2005), n:o 3, Lombardo T., et.al., “Weathering of float glass exposed outdoors in an urban area”, pp. 271-276).

Various solutions to the weathering problem have been suggested, and in principle the alkali metal diffusion barriers discussed elsewhere in this patent application are a potential solution. Ordinary soda-lime glass sheets may also be subjected to a treatment which dealkalizes the glass. British Patent Specification 294,391 describes a method where glass sheets are reheated to 600° C. and exposed to an atmosphere containing sulphur dioxide for about 30 minutes. The furnace gases must also contain oxygen and water. The resulting ion-ecchange process is

2Na⁺(glass)+SO₂+½O₂+3H₂O=2H₃O⁺+Na₂SO₄.

The sodium sulfate crystallizes on the glass surface but does not attack the glass; it can be washed off at lower temperatures. The treatment results in a depletion of the alkali ion content in the surface of the glass. The resulting state of the glass surface is unstable and there is a tendency for sodium ions to migrate towards the surface in order to reestablish the ionic population distribution to equilibrium. U.S. Pat. No. 5,093,196 describes an improved sodium depletion profile, characterized in that over at least a portion of the surface of the glass, the depth at which the sodium ion concentration is 90% of the maximum sodium concentration of the glass is at least twice the depth at which the sodium ion concentration is 50% of said maximum concentration, and the sodium ion concentration at a depth of 50 nm is not more than 50% of said maximum concentration.

U.S. Pat. No. 7,137,276 describes a process for the production of durable photocatalytically active self-cleaning coating on glass. In a photocalytic coating, a hole-electron pair can be generated in sunlight and the pair can react to form hydroxyl and peroxy radicals, which can oxidize organic dirt on the glass surface. The photocatalytic surface also shows hydrophilic properties. A hydrophilic surface will wet the surface better, making the surface easier to clean.

The durability of the photocatalytic coating, especially to abrasion, may be poor. U.S. Pat. No. 7,137,276 states that depositing a tin containing titanium oxide coating on the glass substrate surface results in photocatalytically active slef-cleaning coated glass with high durability, both to abrasion and to temperature cycling in humid atmosphere.

It is obvious that the glass surface may have a dramatic effect on the soiling, weathering and self-cleaning properties (adhesion of the photocatalytic coating) of the glass.

### Adherance to Glass

Adherence to the glass surface is important for many applications. Production of electronic and opto-electronic devices may require depositing a metal film onto a glass surface. The use of glass as a carrier substrate for a large number of uses is well known and according to the usual procedure, a desired chemical substrate is immobilized on the glass surface, usually by using SiOH groups.

U.S. Pat. No. 5,851,366 describes a method for improving adherence of a metal film deposited directly on a silicate glass surface. The method comprises chemically treating the surface of the glass to alter its surface characteristics and thereby improve adhesion of the metal film to the glass surface. In this method a compound, typically an active fluorine compound attacks the glass surface, thereby altering its chemical nature. A possible alteration involves converting Si—O bonds to Si—OH bonds.

The adhering material may also be modified as described e.g. in U.S. Pat. No. 6,855,490 where the protecting group of the icocyanate moiety is displaced by amines, hydroxyl, or carboxyl groups of biological molecules, leading to a covalent attachement to the glass surface.

### Manufacturing of Glass and Glazed Ceramics

Float glass is produced by floating a continuous stream of molten glass onto a bath of molten tin. The molten glass spreads onto the surface of the metal and produces a high quality sheet of glass that may be later heat polished. The glass has no wave or distortion and the float process is now the standard method for glass production and over 90% of the world production of flat glass is float glass.

The batch of raw materials is continuously added to the melting furnace where it is taken to >1000° C. temperature using gas fired burners. The mix then flows over a dam where the continuous stream of molten glass flows onto the bath of molten tin. The stream of glass is pulled along the top of the molten tin by haul-off conveyors at the end of the float area which transport the glass into the annealing lehr. The purpose of annealing glass is to remove internal stresses that might cause later breakage. Stresses are likely to be present because of unequal temperature distribution in the glass article while it is being made. Glass that has not been annealed may shatter from tension caused by uneven cooling. Annealing is done by gradually cooling it according to a planned time-and-temperature schedule.

The modification of the glass surface can take place in the float line in any place between the dam and the annealing lehr entrance. In the annealing lehr (and after it) the glass temperature is too low for efficient nanoparticle diffusion and dissolution. In the melting furnace the temperature is too high and the nanoparticles dissolve completely into base glass.

The production of new high-technology devices, such as the production of active-matrix liquid crustal displays (AMLCD's) requires new properties from the glass substrates used. In the AMLCD manufacturing process etching solutions from acidic to neutral to basic are used, and the glass may undergo only minimal changes during the process. The more durable glass substrates allow the use of more aggressive etching conditions thereby increasing throughput. The mechanical and dimensional tolerances of the AMLCD substrates are very tight. Due to the stringent requirements, new processes have been developed for the production of AMLCD glass substrates, such as the proprietary Fusion process by Corning. In this technique, hot glass is delivered to the top of a refractory pipe where it fills a trough region. The stream divides into two as it flows over the top edges of the pipe, and down its faces. At the bottom edge of this refractory, the two glass streams recombine into a single glass sheet (Advanved Flat Panel Display Technologies Proceedings, Vol. 2174 (1994), Lapp, J. C., et.al., “Advanced glass substrates for flat panel displays”, pp. 129-174). The modification of the glass surface can take place in the area whre the glass surface is sufficiently hot and the different surfaces of the glass may be modified differently, if required.

Glass tempering is a process in which a glass article that is already formed is reheated until almost soft. Then, under carefully controlled conditions, it is chilled suddenly by blasts of cold air, or alternatively by plunging it in oil or certain chemicals in a liquid state. The treatment makes the glass much stronger than ordinary glass.

The modification of the glass surface can take place during the glass reheating in the tempering line or when the glass passes from the reheating furnace to the tempering (air-blasting) chamber. After the glass is chilled, the glass temperature is too low for efficient nanoparticle diffusion and dissolution.

In addition to glass surfaces, glass-like surfaces, like glazed and enameled surfaces can also be modified, like glaze surfaces such as on glazed tiles. Glazing involves applying one or more coats of glaze with a total thickness of 75-500 microns onto the ceramics (tile) proper surface by different methods. Glazing is done to provide the fired product with a series of technical and esthetical properties such as impermeability, cleanability, gloss, colour, surface texture, and chemical and mechanical resistance. The nature of the resulting glaze coating is essentially vitreous, although in many cases the glaze structure contains crystalline elements.

The surface modification of glazed ceramics can be combined to ceramics firing. Firing is one of the most important tile manufacturing process stages as most ceramics characteristics depend on it. These include mechanical strength, dimensional stability, chemical resistance, cleanability, fire resistance, etc. The main variables to be considered in the firing stage are the thermal cycle (temperature-time, and kiln atmosphere, which must be adapted to each composition and manufacturing technology, according to the ceramic product to be made. The surface modification can most easily be combined to the cooling stage of firing, as long as the temperature is higher than 400° C., after which the glaze becomes too viscous for efficient diffusion and dissolution of nanoparticles into the glaze.

It is obvious that surface modification by nanoparticles may also be combined to the production of glass containers, glasses for laboratory and process applications, glasses for lightning, glasses for CRT's and TV picture tubes, glass tube manufacturing, taleware and artware glass manufacturing, whiteware ceramics manufacturing, sanitary ceramics manufacturing and in general any glass and glaze product manufacturing where the temperature of the glass or glaze is suitable for diffusion of nanoparticles into glass or glaze.

### Current Manufacturing Processes for Thin-Film Coatings on Glass

Pyrolytic low-e coatings have been applied both by Chemical Vapor Deposition (CVD) and spray-pyrolysis. CVD methods can be employed in the float glass process in three locations: \textcircled{1} in the tin bath (750-600° C.) \textcircled{2} in between the tin bath and the annealing lehr (600-570° C.), or \textcircled{3} in the annealing lehr, after the annealing zone (<500° C.) (Richard J. McCurdy, Successful implementation Methods of Atmospheric CVD on a Glass Manufacturing Line, Thin Solid Films, vol. 351 (1999) pp. 66-72). In practice the requirement of the fast coating growth rate limits the usable area to the tin bath. Spray-pyrolysis process has been applied in between the tin bath and the annealing lehr, but the process speed does not—most probably—allow the use of this technology with the current float glass production speeds.

CVD methods involve reacting a precursor gas with the hot surface of the glass on the float line. As a result of this chemical reaction, the surface of the glass takes on a new chemical structure. The coating is also referred to as a ‘hard’ coating because the coating becomes part of the surface of the glass and is thus more durable than sputtered coatings. The reactions must occur very quickly to avoid slowing down the float line.

Table I summarizes the production benefits and drawbacks of CVD and sputtered coatings.

TABLE I

| | |
|---|---|
| CVD | Sputtered |

A
Production benefits of CVD and sputtered coatings (David R.
Howell et al., Industrial Materials for the Future R&D Strategies: A Case Study
of Chemical Vapor Deposition (CVD) Methods - Applying Low-E Coatings to
Flat Glass for Applications in Sunbelt Locations, National Renewable Energy
Laboratory, Washington, D.C., and RAND, Arlington. Virginia, USA)

| | |
|---|---|
| Since the deposition of | Batch sputtering is the tradi- |
| coatings is done on-line, CVD offers | tional technique used to deposit coat- |
| excellent lead times. | ings on glass; thus, there is a well- |
| The coatings become a | established understanding of a wide |
| part of the glass, rather than a layer | variety Of candidate materials that can |
| on the surface of the glass, increas- | be used to for a coating. |
| ing their resistance to scratches. This | Processes necessary to |
| eliminates the need for special hand- | apply and handle coatings are well- |
| ling and thus decreases lead times. | established. |
| Coatings have an unlim- | Performance properties of |
| ited shelf life. | sputtered glass are superior to pyro- |
| CVD is done at atmo- | lytic glass for many applications. |
| spheric pressure. | |
| Coatings applied using | |
| CVD are stable to tempering. | |
| There is a consistent ap- | |
| pearance between annealed and | |
| tempered glass used in the same ap- | |
| plication. | |

B
Production drawbacks of CVD and sputtered coatings

| | |
|---|---|
| Coatings must be thickness | Applying coatings off-line |
| insensitive so that variations will not | requires additional processes and |
| result in differences in appearance. | time. In addition coatings must be de- |
| Deposition reactions must | posited in a vacuum chamber. |
| occur very quickly to be applied on the | Since the coating is applied |
| processing line. | as a layer on top of the glass, sput- |
| Since CVD is still maturing | tered glass requires special handling |
| in the glass coating process, informa- | to avoid scratches before installation, |
| tion on types of chemistries that can | thus, promoting longer lead times. |
| be used is limited. This constrains the | Sputtered coatings tend to |
| producer's flexibility in choosing | be more sensitive to moisture in the |
| chemistries based on stability of the | air. This factor limits a sputtered coat- |
| chemicals in delivery lines, uniform | ing's shelf life. Therefore, producers |
| dispersion of reactants on the glass in | must carefully consider the length of |
| the float line, and versatility of deposi- | time between sputtering and installa- |
| tion equipment to facilitate different | tion to avoid loss of stocks. Once in- |
| chemistries. | stalled, however, the coating is insu- |
| Coatings must be uniform | lated, in a double pane, from damage |
| and defect-free. | due to moisture. |
| | Not all sputtered glass can |
| | be tempered. Thise that can be tem- |
| | pered cannot be tempered under |
| | normal tempering conditions. An- |
| | nealed and tempered glass used in |
| | the same application may display dif- |
| | ferences in appearance. |
| | Most manufacturers of |
| | sputtered glass suggest that coatings |
| | on the edge of the glass be deleted. |
| | This creates additional processes, re- |
| | quiring time and equipment. |

Although a vast number of investigations is present in the literature, with many different precursors for deposition of tin oxide, little is known about the chemistry of these processes. In general there is little known (or published) about the specific steps of tin oxide deposition. For monobutyltin trichloride, a common precursor in industry, no growth data have even been reported yet.

Tin oxide films with good optical and electrical properties can be made by CVD using organotin precursors as SnCl₄, TMT, DMTC, MMTC and MBTC. Sheet resistances down to 3Ω/μ have been reported. Optical transmission and infrared reflectivity can be as high as 90%. The properties not only depend on the type of precursor used, but also on the deposition parameters, such as deposition temperature, deposition time, precursor flow rates and concentrations, annealing conditions and additives used. Depositon temperature must be sufficiently high to obtain high growth rates and high conductivity. Higher deposition times also lead to better layer quality.

Tin oxide layers applied in low-e windows need a very low haze value, which can be achieved using MBTC as a precursor. Tin oxide layers in solar cells need a high haze value, which can be achieved by using SnCl₄ and water. Using methanol as an additive in the beginning of the process the right type of morphology can be achieved for an optimal haze ratio (Antonius Maria Bernardus van Mol, Chemical Vapour Deposition of Tin Oxide Thin Films, proefschrift ter verkrijging van de graad van doctor aan de Technische Universiteit Eindhoven, 2003).

### Nanoparticle-Based Glass Surface Modification

FI98832, Method and device for spraying material, relates to a process and a device for spraying various materials, where the material to be sprayed is passed into a flame generated with the aid of fuel gas, which makes it possible to spray the particles of the spray material onto any object. The spray material is passed into the flame in the liquid form and is converted into the droplet form with the aid of the said gas, essentially in the region of the flame. This gives a rapid, advantageous and single-stage method for producing very small particles, which are of the order of magnitude of nanometers.

Applicant's patent application FI20050549, Method and device for coating material describes a method for coating material, where particles are formed from raw materials, an aerosol containing the particles is guided such that particles having an aerodynamic diameter larger than d are removed from the aerosol, d typically being between 0, 1 and 10 micrometers and the remaining particles are deposited on material by thermophoresis. A coating equipment including components for producing particles, components for collecting particles having an aerodynamic diameter larger than d and components for depositing particles smaller than d.

Applicant's patent application FI20050595, Method and device for producing nanosize particles, describes a method for producing nanosize particles, where the particle precursors are mixed at least as liquid droplets and optionally also as gases and/or vapors with the flame-forming gases in the premix chamber, liquid droplets having a diameter larger than d are removed from the mixture after which the mixture is fed at least to one burner head where the burner gases are ignited such that a well mixing flame is generated, where the precursors react and the solvents evaporate, and by particles having an aerodynamic diameter of 1-100 nm are formed by nucleation and/or coalescence and/or agglomeration. An apparatus for producing nanosized particles including the equipment for atomizing liquid, equipment for feeding the atomized liquid to the premix chamber, equipment for feeding the burner gases into the premix chamber, equipment for removing liquid droplets having an aerodynamic diameter larger than d from the mixture, equipment for feeding the mixture to at least one burner head and equipment for producing the flame in the burner.

Applicant's patent application FI20060375, Method and apparatus for coating glass, describes a method for coating glass at 450-750° C. temperature range. The glass can be coated during the float glass production or during glass processing, like glass tempering at the production/processing line speed. At least part of the coating material is deposited as fine particles so that the reaction kinetics (on the surface) of the precursors is not a limiting factor for the coating rate. The coating can be e.g. a low-e coating or a self-cleaning coating.

### OBJECT OF THE INVENTION

In general, changing the glass composition may significantly change the functionality of glass, e.g. its optical properties (including a wide wavelength range covering at least the complete solar spectrum), its hardness and strength, its chemical durability, ionic diffusion in the glass, electrical conductivity, dielectric properties, as well as solubility, permeability and diffusion of gases in glass.

Furthermore, changing the glass composition of the glass-like surface, like glass, glaze or enamel, changes the functionality of the glass and new functionality can be introduced to glass produced or processed by conventional processes like float-glass manufacturing, glass casting, press-and-blow operation, ceramics firing, glass tempering, paste-mold processing, press processing or continuous glass flow forming operations. If the glass surface modification can be integrated to the manufacturing process, a great economical benefit is achieved.

Furthermore, nanoparticles deposited on the glass surface can diffuse and dissolve into the glass matrix when the temperature of the glass surface is suitable, typically the temperature being such that the viscosity of the glass-like surface is 10⁴-10¹⁴ Poise.

On the other hand, for economical production, the nanoparticles need to diffuse and dissolve into the glass surface in a very short time. Thus the nanoparticles are only an intermediate product used to modify the glass structure.

The object of this invention is a method for changing the composition of the glass-like surface in a fast and economical way.

### DISCLOSURE OF THE INVENTION

The inventors found that the above object can be achieved with a method according to the characterizing portion of claim 1 and particularly with a method that is characterized by forming nanoparticles having a reduced cohesive energy or reducing the cohesive energy of the nanoparticles during the production of the nanoparticles or after the production of the nanoparticles, or forming nanoparticles having reduced cohesive energy. The easy disintegration of the nanoparticles provides a faster route for material removal from the nanoparticles and thus faster modification of the glass surface.

In a preferable embodiment of this invention, the nanoparticles are formed through a vapour-phase route, in a way ensuring the formation of easily breakable nanoparticles, the nanoparticles are deposited on a glass-like surface, and the nanoparticles are at least partly diffused and dissolved into the glass matrix, thus changing the composition of the glass-like surface.

Nanoparticles are ultrafine dispersive particles with diameters below 1000 nm, typically below 100 nm. Novel fabrication technology of nanoparticles includes a wide range of vapor, liquid and solid state processing routes. Nanoparticles synthesized from different routes may have different internal structures. Due to their high specific surface areas, nanoparticles exhibit a high reactivity and strong tendency towards agglomeration.

The cohesive energy of a solid equals to the energy dividing the crystal into individually isolated atoms by breaking all bonds of the solid. In ideal system the cohesive energy is the sum of bond energy over all coordinates of all atoms in the crystal. In reality the cohesion energy of the nanostructured material depends also on physical size and on chemical-bond—valence-band—potential-barrier mechanisms. An atom at a site surrounding a defect or near the edge of a surface or in an amorphous phase in which the coordination reduction distributes randomly sees a bond order loss, which lowers the cohesive energy of under-coordinated atom. This reduction in cohesive energy can be seen e.g. in the well-known reduction of the melting temperature for nanoparticles with a radius of less than a few nanometers.

The present invention provides a method for forming nanoparticles with reduced cohesive energy, targeting these nanoparticles on a glass-like surface so that the nanoparticles at least partly diffuse and/or dissolve into the glass matrix and modify its properties.

According to the present invention, the cohesive energy of the nanoparticles formed can be reduced by reducing the nanoparticle size; changing the nanoparticle composition; changing the nanoparticle shape, changing the nanoparticle density or by producing amorphous nanoparticles.

The invention is applicable to the modification of glass surfaces, glaze surfaces, enamel surfaces and similar. Furthermore, the invention is applicable to produce functional surfaces as such or applicable to produce surfaces with improved adhesion properties for coatings.

The modified layer thickness is typically less than 100 micrometers, and preferably less than 10 micrometers thick.

In one set of embodiments, a nanoparticle layer is applied to the glass-like surface by producing nanoparticles, collecting the nanoparticles and targeting the ready-made nanoparticles on the glass-like surface. Nanoparticles may be produced by known production methods with the production process parameters tuned to produce nanoparticles with reduced cohesive energy. The nanoparticles can be collected in dry or wet solutions and the nanoparticles may be targeted on the glass surface by various ways, e.g. by spraying systems. The glass-like surface may be hot, but it may also be cold and be heated afterwards for nanoparticle diffusion and dissolution.

Nanoparticles in this set of embodiments may be produced by vapor-route, liquid-route, solid-route or a combined route. The vapor-route includes physical vapor deposition (PVD), chemical vapor deposition (CVD) and aerosol processing. In PVD vapor phase species are generated via evaporation, sputtering, laser ablation or ion beam. The vapors may be let to react in the gas phase to form nanosize particles. In CVD mainly the modified chemical vapor deposition (MCVD) described elsewhere in this application may be used. The aerosol route involves the atomization of chemical precursors into aerosol droplets that are dispersed through a gas medium. The aerosols are then transported into a heated reactor where the solution is evaporated or combusted to form nanoparticles. The liquid-route includes sol-gel process and wet chemical synthesis, the solid route includes mechanochemical alloying/milling and mechanochemical synthesis and the combined route may be e.g. vapor-liquid-solid approach. A comprehensive review on the methods used for nanoparticle generation can be found in Materials Science and Engineering, vol. 45 (2004), Tjong, S. C., and Chen, H., “Nanocrystalline materials and coatings”, pp. 1-88.

In another set of embodiments, a modified chemical vapor deposition (MCVD) process is used to produce amorphous silica particles used to modify the glass surface for improving the surface hardness. MCVD process differs from the conventional chemical vapor deposition (CVD) process such that the precursor reactions occur in the gas phase rather than on the surface. Amorphous nanoparticles can be generated by tuning the process so that the cooling rate of the seeded nanoparticles is very fast Thus the process can be used to produce nanoparticles with reduced cohesive energy.

In still another set of embodiments, a liquid flame spraying process is used to produce nanoparticles with chain-like morphology or/and nanoparticles having density lower than the bulk material, thus revealing a porous structure of the nanoparticle. Both chain-like and porous nanoparticles have cohesive energies lower than cohesive energy of solid, spherical nanoparticle.

In still another set of embodiments, a nanoparticle production process is used to produce aluminum oxide nanoparticles and electromagnetic radiation, like X-ray, microwave or ultraviolet radiation is used to create defects in nanoparticles. The defected nanoparticle shows a lower cohesive energy that a a non-radiated particle. The aluminum oxide nanoparticles are used to modify the glass-like surface in order to improve its chemical durability.

In still another set of embodiments, a liquid flame spraying process is used to produce nanoparticles having a diameter of less than 10 nanometers, the size of the nanoparticle thus ensuring the reduced cohesive energy, collecting the nanoparticles on a glass substrate by thermophoresis and dissolving/diffusing the particles into the glass matrix by thermal energy.

In a preferred embodiments of the invention, a liquid flame spraying process is used to produce multicomponent nanoparticles, the composition of the particles is designed such that the composition shows a reduced cohesive energy (lower melting temperature), and in the most preferred embodiment shows amorphous and porous structure. The nanoparticles are deposited on the glass-like surface in the production line. In flat glass manufacturing the deposition is done in the float line, in flat glass processing in the tempering line, in ceramic tile manufacturing during the tile firing process and in container glass manufacturing after the press-and-blow operation.

### BRIEF DESCRIPTION OF THE DRAWINGS

Embodiments of the invention will now be described by way of example, with reference to the accompanying drawings in which:

FIGS. 1 and 2 schematically illustrate two ways of forming nanoparticles and depositing the particles on a glass substrate in the first embodiment of the invention.

FIG. 3 schematically illustrates the MCVD process used to produce amorphous SiO₂ particles and depositing them on glass substrate in the second embodiment of the invention.

FIG. 4 schematically illustrates the liquid flame spraying process used to produce non-spherical silica nanoparticles in the third embodiment of the invention. FIG. 4. also schematically illustrates the liquid flame spraying process used to produce very small silica nanoparticles in the fifth embodiment of the invention.

FIG. 5. schematically illustrates a laser ablation process used to produce nanoparticles and an X-ray system used to generate defects on the aluminum oxide nanoparticles produced in the fourth embodiment of the invention.

FIG. 6. schematically illustrates a liquid flame spraying process integrated to a float line and used to produce multicomponent nanoparticles in the sixth embodiment of the invention.

FIG. 7. is a concentration profile of the glass surface modified according to the invention.

FIG. 8. shows the surface of the glass modified using nanoparticles with reduced cohesive energy (B) compared to a glass surface deposited with conventional nanoparticles (A).

### DETAILED DESCRIPTION OF EMBODIMENTS OF THE INVENTION

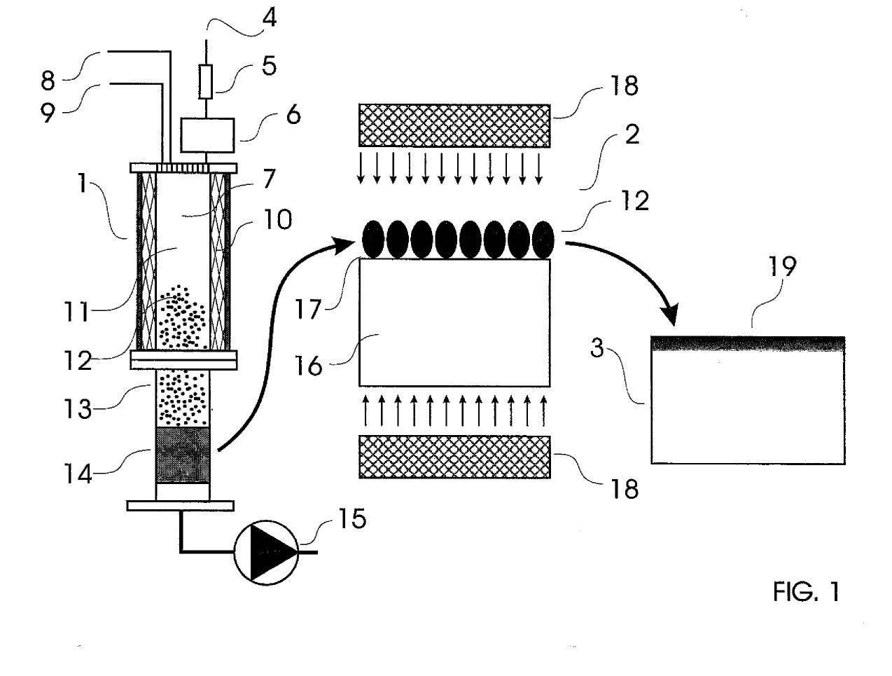

FIG. 1 illustrates a system for forming nanoparticles, transferring them on a glassy surface and diffusing/dissolving the nanoparticles into the glassy surface. The system comprises a nanoparticle formation sector 1 and a deposition section 2 and the outcome from the system is an object 3 with a modified glassy surface 19. Precursor feeding gas 4 is passed through a mass flow controller 5 into a precursor chamber 6 from which the precursor is fed into the hot reaction chamber 7. Additional gases which may take part in the nanoparticle formation reaction are fed into the chamber 7 through gas lines 8 and 9. The walls of the chamber 7 are equipped with heaters 10 which provide the thermal energy necessary for the reactions. The gas atmosphere 11 in the chamber 7 is adjusted so that the nanoparticles 12 born in the chamber 7 do not have a stoichiometric composition, i.e. in general the oxide nanoparticles 12 born show a composition MₓO_{(y-z)}, where z=0 . . . y. the non-stoichiometric particle has a lower cohesive energy than a stoichiometric one with a composition MₓO_{y}. The particles are further fed into the collection chamber 13 where they are collected to a filter 14. The effluent gases are fed from the chamber by a pump 15. The nanoparticles 12 are further deposited on a substrate 16 with a glassy surface 17. The deposited plate is heated by heating plates 18 so that the nanoparticles 12 are diffused and/or dissolved into the glassy surface 17. Thus an object 3 with a modified glassy surface 19 is formed. The nanoparticles 12 created in the system can be e.g. oxides of Li, Be, B, Na, Mg, Al, Si, P, K, Ca, Sc, Ti, V, Cr, Mn, Fe, Co, Ni, Cu, Zn, Ga, Ge, As, Se, Rb, Sr, Y, Zr, Nb, Mo, Tc, Ru, In, Sn, Sb, Cs, Ba, La, Hf, Ta, W, Re, Pb, Bi, Ce, Pr, Nd, Pm, Sm, Eu, Ho, Er, Tm, Yb, or Lu, oxides of the elements above which have been doped by e.g. C, N, F, S, Cl, Br, Ag, Au, Pd, Pt or Rh, or combined oxides of the elements and doping agents above. The precursor source can be solid, liquid or gaseous and it can be any organic or inorganic compound of the elements.

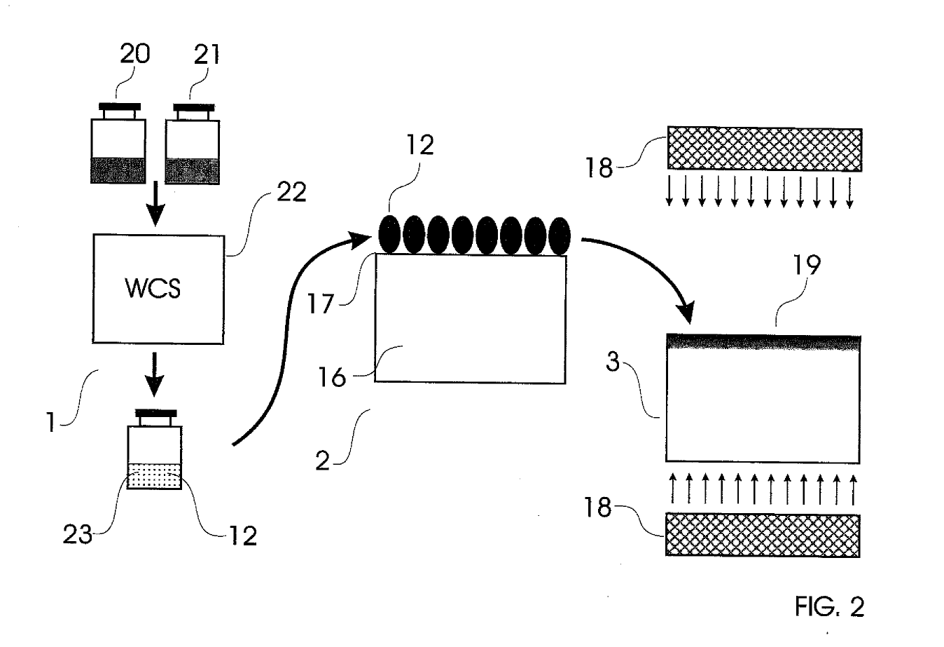

FIG. 2 illustrates another system for forming nanoparticles, transferring them on a glassy surface and diffusing/dissolving the nanoparticles into the glassy surface. The system comprises a nanoparticle formation sector 1 and a deposition section 2 and the outcome from the system is an object 3 with a modified glassy surface 19. Liquid precursors 20 and 21 are mixed in a wet chemical synthesis reactor 22 and nanoparticles 12 are formed in a solution 23. The raw materials 20 and 21 and the wet chemical synthesis is adjusted so that the nanoparticles 12 born do not have a stoichiometric composition, i.e. in general the oxide nanoparticles 12 born show a composition MₓO_{(y-z)}, where z=0 . . . y. the non-stoichiometric particle has a lower cohesive energy than a stoichiometric one with a composition MₓO_{y}. The nanoparticles 12 are further deposited on a substrate 16 with a glassy surface 17. The deposition can be done e.g. by a mist spraying system not shown in the figure. The deposited plate is heated by heating plates 18 so that the nanoparticles 12 are diffused and/or dissolved into the glassy surface 17.

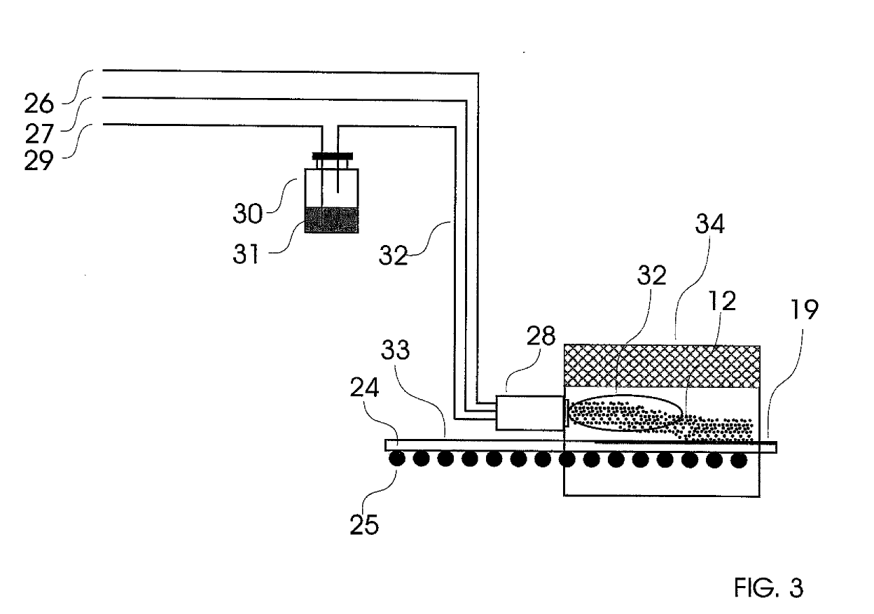

FIG. 3 illustrates a system for producing a silica-modified surface on a glass surface. A flat glass 24 moves on transport rolls 25. Hydrogen gas (H₂) 26 and oxygen gas (O₂) 27 are fed into a modified chemical vapor deposition burner 28. Nitrogen gas (N₂) 29 is fed through a bubbler 30 containing silicon tetrachloride (SiCl₄) 31. The halide is heated to approximately 50° C. temperature (the heater is not shown in the figure). Nitrogen gas containing silicon tetrachloride vapor is fed into the burner 28 through a heated delivery line 32. Hydrogen and oxygen gases form a flame 32 at the exit of the burner 28. SiCl₄ forms SiO₂ particles in the flame. The velocity and turbulence of the flame 32 are high and thus the residence time of the nanoparticles 12 in the flame 32 is short, typically in the order of a millisecond. Thus the cooling rate of the nanoparticles 12 is very fast, typically higher than 10 000 K/s and the nanoparticles 12 are amorphous silica, with lower cohesive energy than crystalline SiO₂. The nanoparticles 12 are collected on the flat glass surface 33 by using a thermophoretic collector 34. Nanoparticles 12 diffuse and/or dissolve into the glass surface 34 forming a modified glassy surface 19.

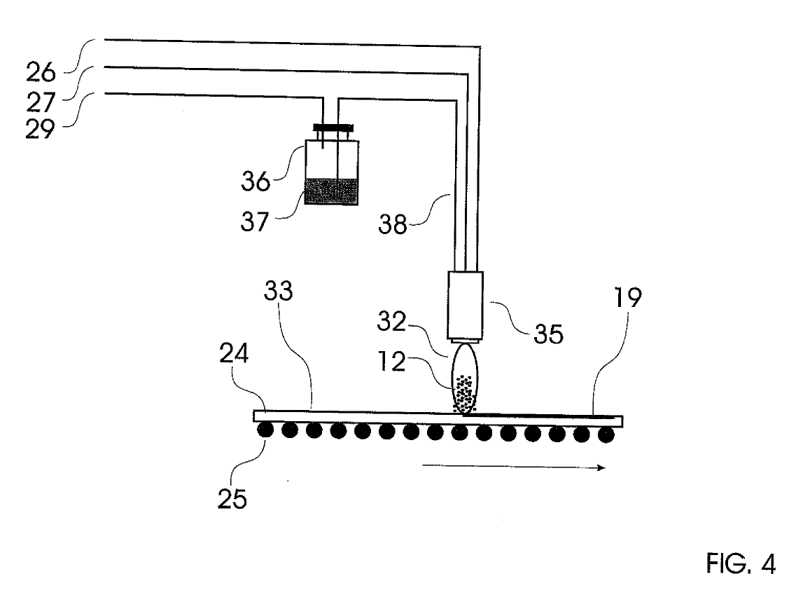

FIG. 4 illustrates another system for producing a silica-modified surface on a glass surface. A flat glass 24 moves on transport rolls 25. Hydrogen gas (H₂) 26 and oxygen gas (O₂) 27 are fed into a liquid flame spraying burner 35. Nitrogen gas (N₂) 29 is used to pressurize the liquid raw material source 36 which contains tetra-ethyl-ortho-silicate (TEOS) 37. TEOSn 37 is fed to burner 35 through a liquid delivery line 38. Hydrogen and oxygen gases form a flame 32 at the exit of the burner 35. SiCl₄ forms SiO₂ particles in the flame. The mass flow rate of TEOS to the burner is kept low and thus the nanoparticle 12 density in the flame is low, typically less than 10⁹ 1/cm³. The flame speed and turbulence are such that the residence time in the flame is low and due to the low density and high process speed the born nanoparticles 12 remain small, typically less than 10 nm in diameter. Nanoparticles of this size show a reduced cohesive energy. The nanoparticles 12 are collected on the flat glass surface 33. Nanoparticles 12 diffuse and/or dissolve into the glass surface 33 forming a modified glassy surface 19.

Nanoparticles 12 in the system illustrated in FIG. 4 can also be formed so that their density is different from the density of solid SiO₂ particles. The effective particle density of nanoparticles 12 can be calculated by comparing the aerodynamic particle diameter da, measured e.g. by Electrical Low pressure Impactor ELPI (Dekati Oy, Tampere, Finland) and the mobility diameter db, measured by a Differential Mobility Analyzer DMA (TSI Inc., MN, USA, Model 3081). The measurement results show that nanoparticles with either lower or higher densities than the density of a spherical, solid SiO₂ nanoparticle can be produced. The lower densities refer to nanoparticles with porous or chain-like structure and the higher densities refer to nanoparticles with lower oxygen content, even down to metallic Si nanoparticles. Both low-density and high-density particles have effective cohesive energies which are lower than the cohesive energy of solid, spherical SiO₂ nanoparticles.

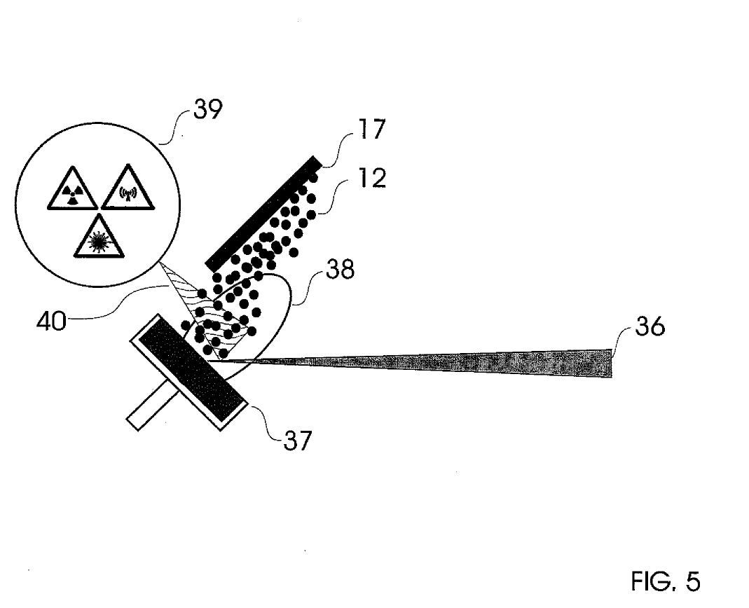

FIG. 5 illustrates a system for producing Al₂O₃ particles by using pulsed laser ablation process. A laser beam 36 is focused on a rotating target 37, the material of the target being Al₂O₃. The laser energy evaporates TiO₂ from the target 37 and forms a material plume 38. The nanoparticles 12 are formed in the plume 38 or after it. A radiation source 39 is assembled on the system so that the nanoparticles will pass the radiation flux 40. Radiation source 39 may emit any electromagnetic radiation such as X-ray, microwave or ultraviolet radiation. The radiation flux 40 generates defects on and in the nanoparticles 12. The defects in the nanoparticle structure cut the covalent bonds and lower the cohesive energy of nanoparticles 12. The nanoparticles are further collected on a substrate with a glassy surface 17 and the substrate can be further processed to generate an object with a modified glass-like surface.

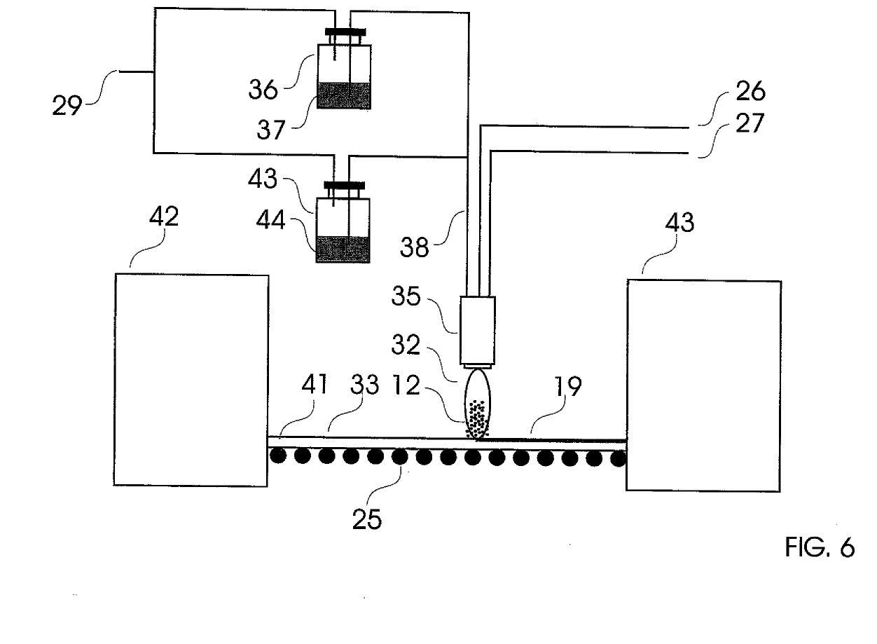

FIG. 6 illustrates a system for producing a modified glass surface in a float glass line. Float glass 41 moves on transport rolls 25 from the tin bath 42 to an annealing furnace 43. Hydrogen gas (H₂) 26 and oxygen gas (O₂) 27 are fed into a liquid flame spraying burner 35. Nitrogen gas (N₂) 29 is used to pressurize the liquid raw material source 36 which contains tetra-ethyl-ortho-silicate (TEOS) 37. N₂ 29 is also used to pressurize the liquid raw material source 43, which contains cobalt(II)nitrate, hexahydrate (Cu(NO₃)₂.6H₂O) dissolved in methanol 44. The liquid materials are fed to burner 35 through a liquid delivery line 38. Hydrogen and oxygen gases form a flame 32 at the exit of the burner 35. CoO—SiO₂ particles are formed in the flame. These particles show a lower cohesive energy (lower melting point) than CoO or SiO₂ particles alone. The nanoparticles 12 are collected on the float glass surface 33. Nanoparticles 12 diffuse and/or dissolve into the glass surface 33 forming a modified glassy surface 19.

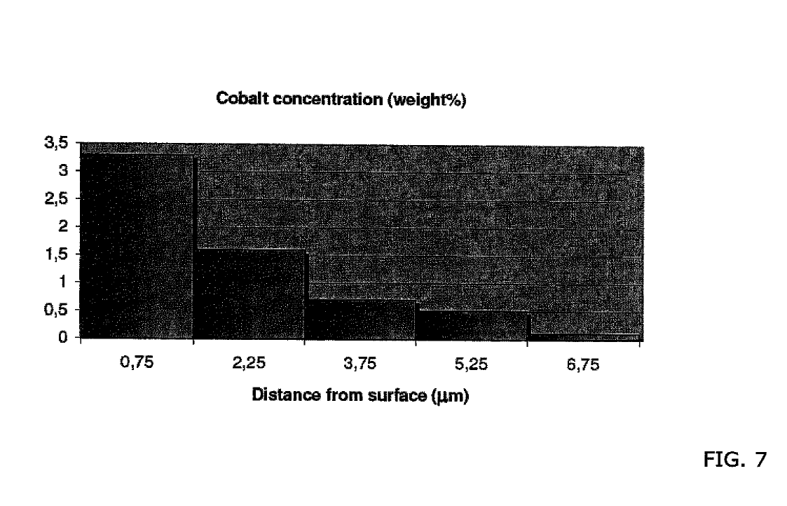

FIG. 7 illustrates the penetration of cobalt oxide into the glass structure from nanoparticles with reduced cohesive energy with a glass surface temperature of 650° C., i.e. a temperature which is an outstanding operating temperature for glass surface modification both in float glass, glass tempering and tile firing lines.

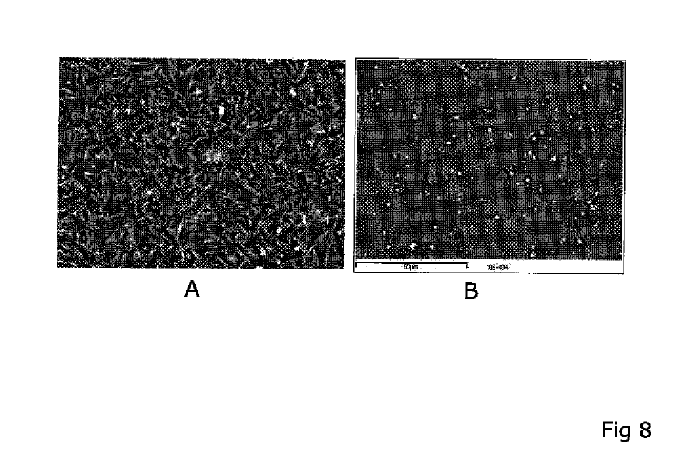

FIG. 8 illustrates the difference in glass coating by conventional nanoparticles and particles with reduced cohesive energy showing the much lower crystallization tendency for particles with reduced cohesive energy (FIG. 8B compared tom FIG. 8A).

Various modifications and changes in the embodiments subscribed hereinabove will occur to the artisan. The present invention embraces all such modifications and changes, and should only be limited within the scope of the appended claims.

1-20. (canceled)

21. A method for modifying glassy surfaces, comprising the steps of:
producing nanoparticles;
depositing the said nanoparticles on a surface;
providing energy to the particles and/or surface so that the nanoparticles are at least partly diffused/dissolved into the glassy surface, wherein the cohesive energy of the nanoparticles is lowered after the production of the nanoparticles by producing defects in or/and on the nanoparticles.

22. The method of claim 21, wherein the defects are generated by irradiating the nanoparticles with ionizing or non-ionizing radiation.

23. The method according to claim 21, wherein the said nanoparticles have an aerodynamic diameter of less than 1000 nm and preferably less than 100 nm and more preferably less than 10 nm.

24. The method according to claim 21, wherein the nanoparticles are metal oxides or doped metal oxides.

25. The method according to claim 21, wherein the nanoparticles are non-stoichiometric oxides.

26. The method according to claim 21, wherein the nanoparticles are amorphous.

27. The method according to claim 21, wherein the nanoparticles have a density different from solid, spherical metal oxide nanoparticles.

28. The method of claim 21, wherein the method is applied to float glass during float glass manufacturing with the glass surface temperature being 500-1000° C.

29. The method of claim 21, wherein the method is applied to flat glass during flat glass processing with the glass surface temperature being 500-1000° C.

30. The method of claim 21, wherein the method is applied to container glass during container glass manufacturing process with the glass surface temperature being 500-1000° C.

31. The method of claim 21, wherein the method is applied to glazed ceramic tile manufacturing during the firing process with the tile glazed surface temperature being 500-1000° C.

32. The method of claim 21, wherein the method is applied in the production of surface-tinted glass.

33. The method of claim 21, wherein the method is applied in improving the chemical durability of glass.

34. The method of claim 21, wherein the method is applied in improving the surface hardness of glass.

35. The method of claim 21, wherein the method is applied in improving the strength of glass.

36. The method of claim 21, wherein the method is applied in producing a barrier layer for alkaline diffusion in glass.

37. The method of claim 21, wherein the method is applied for producing photocatalytic surfaces on glass.

38. The method of claim 21, wherein the method is applied in producing a layer on glass for improving adherence on glass.

39. The method of claim 21, wherein the method is applied in producing transparent conductive oxide layer on glass.

40. The method of claim 21, wherein the nanoparticles are produced by vapor-route, liquid-route, solid-route or a combined route.
